(19) United States
(12) Patent Application Publication
(10) Pub. No.: US 2026/0090561 A1
(43) Pub. Date: Apr. 2, 2026

(54) COFFEE ROASTING METHOD

(71) Applicant: Bai-Shiou Chen, Taipei City (TW)

(72) Inventor: Bai-Shiou Chen, Taipei City (TW)

(21) Appl. No.: 18/898,724

(22) Filed: Sep. 27, 2024

(51) Int. Cl. A23F 5/04; A23F 5/08; A23F 5/26

(52) U.S. Cl. CPC A23F 5/04; A23F 5/08; A23F 5/26

(57) ABSTRACT

A coffee roasting method includes selecting a plurality of coffee beans, preheating a bean roasting bin to then add the coffee beans therein in order to heat the coffee beans to a temperature recovery point, continuously heating the coffee beans to set an internal water temperature of the coffee beans on an edge of evaporation of 90° C.-100° C. in order to soften the coffee bean fibers, following a temperature rise rate of the previous step to continuously heat, within a range of ±1.5 degrees/minute of such a temperature rise rate, the coffee beans to have a water content less than 5%, then controlling temperature such that during first cracking, chlorogenic acid in the coffee beans undergoes a dehydration reaction in a condition of water insufficiency so as to convert into chlorogenic acid lactone; and finally, before second cracking, ensuring the coffee beans are taken out before degradation of chlorogenic acid lactone.

### BACKGROUND OF THE INVENTION

### (a) Technical Field of the Invention

The present invention provides a coffee roasting method that effectively controls the reaction of chlorogenic acid in coffee beans to generate chlorogenic acid lactone and avoids the degradation of chlorogenic acid lactone for subsequent brewing of good-flavored coffee.

### (b) Description of the Prior Art

The coffee market has been vividly developed in recent years. More and more people love to drink coffee, and more and more people know how to drink coffee. Coffee is no longer just a refreshing tool, but also a manifestation of people's attitude towards life, or an improvement of life taste. As the demand for coffee gradually increases, various needs gradually become more diverse. The most common requirement is coffee flavor, and the key to coffee flavor lies in the stimulation of taste and smell.

A lot of explanations have been made in articles of which the contents are nothing more than how to select coffee beans, how to extract the ingredients in coffee, how to add coffee aroma, or how to brew coffee. These are different opinions on experience, and they all make sense to some extents. However, coffee beans are different due to various factors concerning varieties, cultivation areas, post-processing conditions, and so on, and it is impossible to equally apply the way of processing a certain kind of coffee to all kinds of coffee beans. Different varieties of coffee beans have their own ingredients that are not exactly the same, and the differences in ingredients will directly affect the way of extraction. Different cultivation areas will produce coffee beans with different densities, and the differences in densities will affect the content of each ingredient and be reflected in its aroma and taste. Different coffee bean post-processing conditions will at least create different coffee beans having different water contents, and the differences in water contents will affect the chemical reaction during the roasting and heating process.

There are also many articles pointing out that the main ingredient in coffee is chlorogenic acid, emphasizing that chlorogenic acid has various functions, such as antioxidant, lowering body fat, lowering blood lipids, anti-inflammation, protecting liver, eliminating fatigue, controlling blood sugar, inhibiting melanin precipitation, and so on. Among all plants, coffee has the highest content of chlorogenic acid. Therefore, many medical studies have confirmed that chlorogenic acid has many benefits for the human body, and when undergoing a dehydration reaction, chlorogenic acid generates chlorogenic acid lactone, which, when tasted, may induce a sense of layering as turning from bitter to sweet, and this is a good bitter taste. However, coffee will be heated during the course of roasting and this promotes the decomposition of chlorogenic acid. Under a condition of sufficient water, chlorogenic acid is fully hydrolyzed into quininic acid and caffeic acid. Quininic acid will be hydrolyzed to generate quininic acid lactone, which is bitter in taste. Decarboxylation of caffeic acid generates vinyl catechol of which the taste is even more bitter and astringent. Further, chlorogenic acid lactone, if subjected to an excessively high heating temperature, degrades into quininic acid and other compounds, making it difficult to retain chlorogenic acid lactone.

Thus, there are still the following shortcomings to be overcome for the process of roasting coffee beans:

Firstly, most people just blindly try various parameters such as temperature, time, and pressure during the process of roasting, and repeatedly spend a lot of time on coffee beans under different conditions, but do not achieve stable results of roasting.

Secondly, although certain people will try their best to imitate the roasting curves of masters and even use high-end roasting equipment to accurately control various parameters, they do not delve into the meaning behind the curves, and consequently, when there are slight differences in the conditions of coffee beans, they will not be able to obtain the same results of roasting.

Thirdly, even if the coffee beans are strictly selected and the roasting curve is accurately controlled, the thermal decomposition reaction of the chlorogenic acid component in the coffee beans being not controlled may result in the hydrolysis of chlorogenic acid into quininic acid and caffeic acid, greatly destroying the taste of coffee.

Fourthly, re-degradation issues are ignored after chlorogenic acid is converted into chlorogenic acid lactone, making it still impossible to brew coffee with good flavor, and all efforts get in vain.

### SUMMARY OF THE INVENTION

The present invention aims to provides a coffee roasting method that effectively controls the reaction of chlorogenic acid in coffee beans to generate chlorogenic acid lactone and avoids the degradation of chlorogenic acid lactone for subsequent brewing of good-flavored coffee.

The main purpose of the present invention is to reduce the water content of coffee beans to less than 5% during the steaming stage, and to have chlorogenic acid undergoing a dehydration reaction to form chlorogenic acid lactone when the coffee beans enter the first cracking stage, and during continuous roasting, to stop roasting and take out the coffee beans before the second cracking and before the degradation of chlorogenic acid lactone, so that the ingredients of the coffee beans so roasted contain a high proportion of chlorogenic acid lactone, as compared to components produced by a thermal reaction of quininic acid and caffeic acid, so as to enhance the flavor of coffee brewing.

To achieve the above purpose, the steps of the present invention include: first selecting a plurality of coffee beans, preheating a bean roasting bin to then add the coffee beans therein and heating the coffee beans to a temperature recovery point, continuously heating the coffee beans to set an internal water temperature on an edge of evaporation of 90° C.-100° C. in order to soften the coffee bean fibers, continuously heating within a range of the temperature rise rate ±1.5 degrees/minute by following the temperature rise rate of the coffee beans until a water content of the coffee beans is less than 5%, then controlling temperature such that during first cracking, chlorogenic acid in the coffee beans undergoes a dehydration reaction in a condition of water insufficiency so as to convert into chlorogenic acid lactone, and finally, before second cracking, taking out the coffee beans and stopping roasting to avoid degradation of chlorogenic acid lactone.

Therefore, when a user roasts coffee with the roasting method according to the present invention, the initial focus is to slowly heat the coffee beans to allow the coffee bean fibers to be fully softened by the water contained in the coffee beans or the water vapor dispersing during the course of roasting, so that the internal water can easily disperse to the outside, and continuing to heat the coffee beans at this temperature rise rate to have the water content of the coffee beans become lower than 5% before first cracking. As such, the coffee beans are prevented from entering the hydrolysis reaction due to insufficiency of water, and the reaction of chlorogenic acid reaction to form quininic acid or caffeic acid can be avoided, while chlorogenic acid is caused to undergo a dehydration reaction to generate chlorogenic acid lactone. Chlorogenic acid lactone has a bitter and sweet taste and is an obviously better taste when compared with the bitterness of the components produced by thermal reaction of quininic acid and the ingredient of the component produced by the thermal reaction of caffeic acid. Afterwards, when the heating is made to enter the first cracking region, chlorogenic acid is heated to enter a dehydration reaction and be converted into chlorogenic acid lactone. Finally, the coffee beans are taken out before the second cracking to stop roasting so as to prevent chlorogenic acid lactone from degrading to generate excess compounds, so that the high proportion of chlorogenic acid lactone in the coffee beans can be utilized to enhance the overall flavor.

Through the above technology, it is possible to overcome the problems of the known coffee bean roasting processes, in which it is not possible to achieve the same or stable results simply by blindly trying or imitating roasting curves under different conditions such as different varieties and different production areas and the coffee favor cannot be enhanced resulting from no controlling of the thermal decomposition reaction of chlorogenic acid or no controlling of the degradation of chlorogenic acid, so as to achieve the practical improvement for the above advantages.

### BRIEF DESCRIPTION OF THE DRAWINGS

FIG. 1 is a flow chart of a preferred embodiment of the present invention.

FIG. 2 is a schematic view illustrating steaming according to the preferred embodiment of the present invention.

FIG. 3 is a schematic view illustrating hydrolysis rection of chlorogenic acid according to the preferred embodiment of the present invention.

FIG. 4 is a schematic view illustrating dehydration rection of chlorogenic acid according to the preferred embodiment of the present invention.

FIG. 5 is a schematic view illustrating low temperature brewing according to the preferred embodiment of the present invention.

### DETAILED DESCRIPTION OF THE PREFERRED EMBODIMENTS

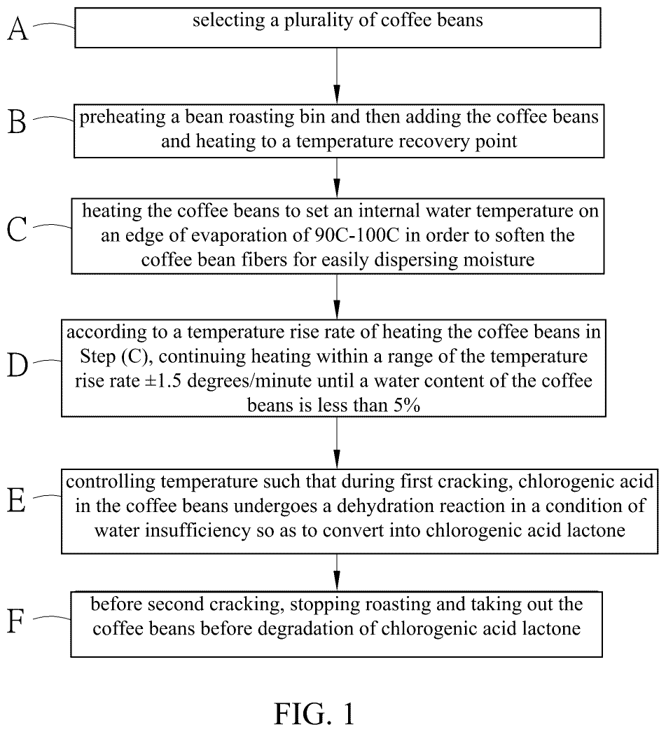

Referring to FIGS. 1-5, which are respectively a flow chart to a schematic view of low temperature brewing according to a preferred embodiment of the present invention, it can be clearly seen from the drawings that the steps of the present invention comprise:
(A) bean selecting: selecting a plurality of coffee beans;
(B) preheating: preheating a bean roasting bin and adding the coffee beans and heating to a temperature recovery point;
(C) steaming: heating the coffee beans to set an internal water temperature on an edge of evaporation of 90° C.-100° C. in order to soften the coffee bean fibers for easily dispersing moisture;
(D) roasting: according to a temperature rise rate of heating the coffee beans in Step (C), continuing heating within a range of the temperature rise rate ±1.5 degrees/minute until a water content of the coffee beans is less than 5%;
(E) dry-distilling: controlling temperature such that during first cracking, chlorogenic acid in the coffee beans undergoes a dehydration reaction in a condition of water insufficiency so as to convert into chlorogenic acid lactone; and
(F) bean unloading: before second cracking, stopping roasting and taking out the coffee beans before degradation of chlorogenic acid lactone.

Preferably, a density of the coffee beans in Step (A) is 830 g/L to 930 g/L.

Preferably, in Step (D), the coffee beans are caused to reach a moisture content of less than 8% before 140° C.

Preferably, in Dtep (D), the coffee beans are caused to reach a moisture content of less than 5% before 180° C.

Preferably, in Step (E), the temperature is controlled before sucrose in the coffee beans begins to melt.

Preferably, in Step (F), a roasting degree (Agtron) of the coffee beans is controlled to be greater than 52 before the second cracking for taking out the coffee beans.

Through the above description, the structure of the present invention can be understood, and based on the corresponding coordination of the structure, it is possible to effectively control the reaction of chlorogenic acid in coffee beans to generate chlorogenic acid lactone, and avoid the degradation of chlorogenic acid lactone, in order to achieve the advantage of subsequent stable brewing of good-flavored coffee. It can be clearly seen from the drawings that in the bean selecting step, since the moisture content of commercially available coffee beans mostly falls between 8%-13%, it only needs to select, among the same batch of roasted coffee beans, coffee beans that are the same or similar with respect to varieties, cultivation sites, and cultivation conditions (including moisture content). Of course, it is especially good to select coffee beans with a density of 830 g/L to 930 g/L, because altitude is one of the main factors that affects the density of coffee beans. The higher the altitude and the colder the climate, the slower the respiration rate of coffee cells, and the slower the growth rate of coffee cherries (ripe coffee fruits), which means that coffee cherries can retain more sugar and aromatic substances, but if the altitude is too high, coffee beans will suffer from frost problems. Therefore, coffee beans from coffee production areas of an altitude of 1800 m to 2300 m are more capable of producing coffee beans with a density of more than 830 g/L. However, the number of coffee beans with a density above 930 g/L is small and the acquisition cost is high, so it is more appropriate to select coffee beans with a density of 830 g/L to 930 g/L. After bean selecting is completed, preheating of the bean roasting bin can be carried out, and then, the coffee beans are placed therein to be heated to the temperature recovery point.

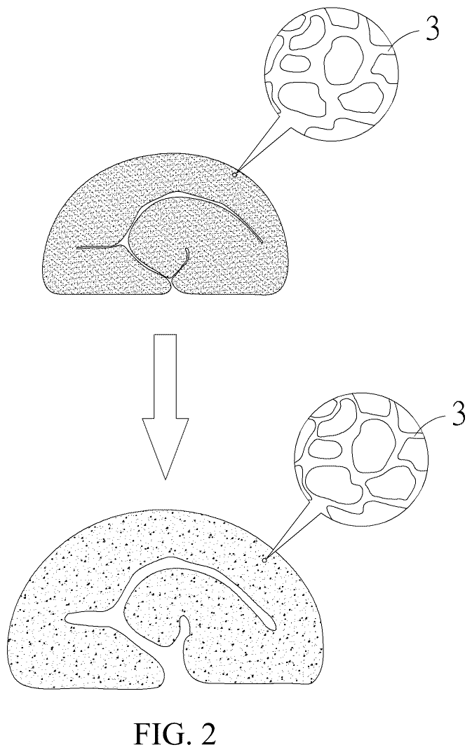

In the steaming step, the main purpose is to control the temperature rise curve to become flat, and to control the temperature at a curve of 90° C.-100° C., so that the water contained in the coffee beans is set at a temperature on an edge of evaporation, so as to soften polysaccharide cellulose of the coffee beans, allowing the water contained in the coffee bean to more easily penetrate a cell wall 3 of the coffee beans after turning into water vapor for dispersing and discharging. As shown in FIG. 2, a schematic diagram of slices of coffee beans before and after steaming is provided for illustration. Because water molecules, after vaporizing, increase in volume and compress the cell wall 3 composed of cellulose, making the cell wall 3 expanded and thinning the wall. This step is not limited to continuous heating completed at one time, but can also be performed in such a way that after one-round of heating, cooling is first carried out and then second-round of roasting and steaming is performed.

Then, entering the roasting step, due to the softening of coffee bean fibers in the steaming step, the surface of the coffee beans will begin to expand during this step, causing most of the water in the coffee beans to be discharged from the surface. Therefore, if the selected coffee beans have more water content, the discharged water vapor is more, but there will still be a small amount of water attached to the coffee bean fibers, so that there is still a limit to the reduction in water content before the first cracking, and similarly, there is also a limit to the amount of water that are attached to the coffee bean fibers. Thus, regardless of the water content of the selected coffee beans, it can be effectively reduced in this step. However, for heating, attention must be paid that heating must be carried out at a gentle temperature rise rate to prevent the surface of the coffee beans from becoming vitrified and preventing water from dissipating smoothly, or to prevent the dehydration rate from being too fast to cause small substances from decomposition of chlorogenic acid to evaporate with the water vapor so as to affect the flavor of coffee, or causing the water on the surface of the coffee beans and the core of the coffee beans to evaporate unevenly, resulting in a grassy or bitter taste. Compared with the steaming step, the temperature rise rate at this time is controlled within a range of ±1.5 degrees/minute. For example, if the temperature rise rate of the steaming step is 6.5° C./min, then the temperature rise rate of the roasting step is 5° C./min-8° C./min, so as to lengthen the heating time to allow water to be discharged as much as possible. For, temperature inside and outside the bean roasting bin and the beans are made as uniform as possible during heating to make the overall temperature of the two are consistent, which is more conducive to temperature control. If controlled properly, the water content of the coffee beans can be reduced to less than 8% before 140° C., and even better, the water content of the coffee beans can be reduced to less than 5% before 180° C.

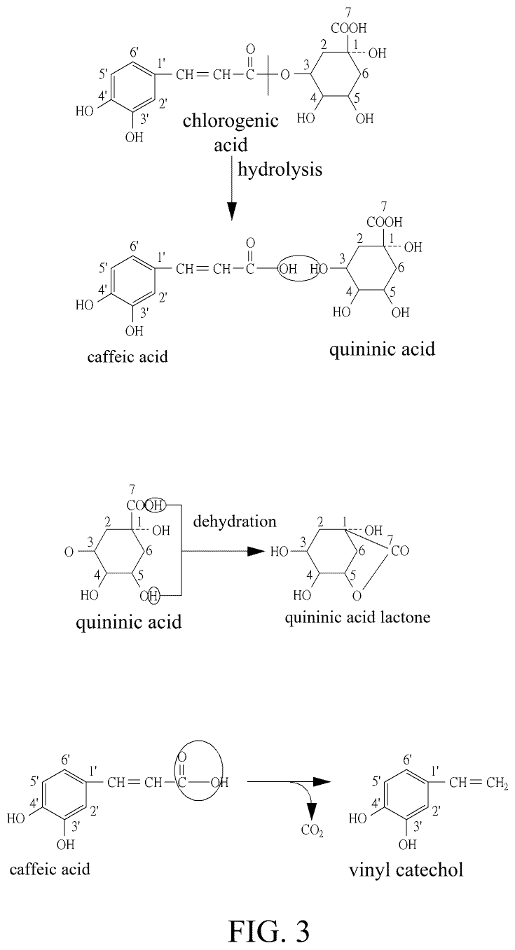

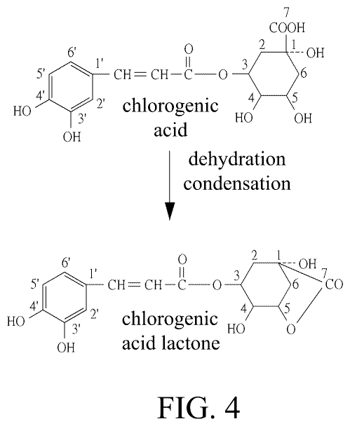

The lower the water content achieved through the roasting step, the more advantageous it is when entering the dry distillation step, because the purpose of dry distillation is to allow chlorogenic acid in the coffee beans to undergo a dehydration reaction in a condition of insufficient water. In the case of sufficient water, chlorogenic acid can be fully decomposed into caffeic acid and quininic acid, as shown in FIG. 3, where the bonding (the marked site) between the carbon atom (C) and the oxygen atom (O) at the center of chlorogenic acid breaks to then respectively combined with the hydroxide radical (OH⁻) and hydrogen radical (H⁺) of water molecules. This process is the hydrolysis reaction (the reaction shown in the upper portion of FIG. 3). After the first cracking, the water contained in the coffee beans is completely dispersed, and if the beans are continuously heated at this time, the molecules in the chemical structure will be forced to dehydrate. For quininic acid, the way of dehydration is to have the hydroxide radical (OH⁻) of the carboxyl group (COOH) that originally exhibits the acid characteristics combined with the hydrogen of another hydroxide (OH) to form water, so that quininic acid undergoes dehydration reaction to become quininic acid lactone (the reaction shown in the middle portion of FIG. 3), so as not to exhibit the acid characteristics and the taste will be bitter; for caffeic acid, it undergoes a thermal decarboxylation (removal of CO₂) reaction to become vinyl catechol (the reaction shown in the lower portion of FIG. 3). The phenolic structure of vinyl catechol is a polymer, and the taste of such a substance is bitter and astringent, the bitterness being located at the base of the tongue and throat, and the vinyl structure of vinyl catechol can form polyethylene if being subjected to continuous heating, polyethylene being bad bitter in terms of taste. Therefore, it is desired to have chlorogenic acid undergoing a dehydration reaction in the absence of water to have quininic acid in the chlorogenic acid molecule partially dehydrated to form chlorogenic acid lactone, as shown in FIG. 4. The taste of chlorogenic acid lactone exhibits layering as turning from bitter to sweet and is a good bitter taste.

The dry distillation step also involves a high-temperature pyrolysis reaction (Pyrolysis). The initial stage of this step is about 180° C., and the sugars in the coffee beans undergo a caramelization reaction at about 170-200° C. and begin to produce a roasted aroma and aroma of other aromatic substances (such as maltol), wherein the melting point of sucrose is about 186° C., and the starting temperature of the first cracking is also around this. Therefore, when sucrose begins to melt, it means that the coffee beans are about to enter the first cracking, and the coffee beans will enter true dehydration, which is different from dehydration in the steaming and roasting steps, but will force chlorogenic acid to dehydrate to form chlorogenic acid lactone.

In the bean unloading step, although chlorogenic acid lactone is the main source of the “coffee flavor” and is known as the pleasant bitter taste, when the roasting temperature of the coffee beans reaches 210° C.-220° C., chlorogenic acid lactone will degrade again, which is also referred to as cracking, to be decomposed again into various compounds such as quininic acid and phenylindane with a metallic taste. Therefore, the degradation of chlorogenic acid lactone obviously produces a bad taste, and it is necessary to stop the roasting and take out the coffee beans before chlorogenic acid lactone degrades to complete the bean unloading step. It can be seen that coffee with light roast or below medium-light roast does not need to be heated to such a high temperature, and it is easy to fulfill bean unloading before the degradation of chlorogenic acid lactone, but medium roast coffee is more difficult to handle, and generally speaking, there is a better chance to keep most chlorogenic lactone if unloading is performed before the second cracking. However, the temperature of the second cracking also varies greatly depending on the type of coffee beans. Therefore, it is a better choice to use the roasting degree (Agtron number, also known as the Agtron value) as the basis for judgment. The Agtron number ranges from 0 to 100, and a high value indicates a low degree of roasting, and the color is light, and the temperature of bean roasting and unloading is low. On the contrary, a low value indicates a high degree of roasting, and the color is dark brownr, and the temperature of bean roasting and unloading is high. An Agtron coffee analyzer can be used to detect the degree of roasting through spectrum, or the standard color card of the Specialty Coffee Association of America (SCAA) can be used to compare the appearance color of coffee beans to learn the Agtron value. Basically, as long as the coffee beans are removed before the roasting degree of the coffee beans becomes greater than 52 before the second cracking, the percentage of chlorogenic acid lactone undergoing degradation can be controlled very low, and the coffee with better flavor can be obtained during brewing.

The coffee beans obtained by the roasting method of the present invention can be directly ground and brewed, or made into coffee bags for brewing. Although the present invention has controlled the ingredients in the coffee beans to have a high proportion of chlorogenic acid lactone, good coffee beans, if brewed in an improper way, may still be possibly destroyed. Thus, making coffee beans into coffee powder to be brewed by adding water therein in such in such a way that, during the course of brewing, the powder to water ratio is made to be 1:20 to 1:33, such as brewing 10 grams of coffee with 220 cc-330 cc of water, to coffee of better flavor. This is related to the extraction degree of coffee. About 28% of the substances in coffee beans can be dissolved by water, and generally speaking, the more water and the higher the water temperature, the more it can be dissolved, but due to the fact that a wide variety of substances contained in coffee beans, under-extraction and over-extraction both seriously affect the flavor. As for the amount of water, it needs to be controlled with the ratio of powder to water, otherwise an excessive amount of water will still dissolve extract substances, this part being related to the Gold Cup theory proposed by the Specialty Coffee Association of Europe (SCAE), which believes that good-tasting coffee must meet two conditions that the grinding and extraction rate is between 18%-22% and the coffee concentration is within the range of 1.2%-1.45%. Based on the content (28%) of water-soluble ingredients in coffee beans, it can be seen that for the same 10 grams of coffee, brewing performed according to the Golden Cup theory will have the largest amount of brewing water that is 2.8(g)/1.45%(g/ml)=193(ml), while the average hand-brewed coffee is less than 200 cc at most. In other words, the present invention makes it possible to still brew good coffee with the powder-to-water ratio of brewed coffee being 1:20 to 1:33, meaning based on the roasting method according to the present invention, it may still be possible to brew 200 cc-330 cc coffee drinks with 10 grams of coffee. Therefore, the user can use a less amount of coffee to brew coffee, and the cost is reduced. Since the substances decomposed from chlorogenic acid are small molecules, while the molecules produced by the caramelization reaction are medium molecules, and caffeine is an alkaloid substance of a large molecule, during extraction, the substances decomposed from chlorogenic acid will dissolve first, and according to the roasting method of the present invention, what dissolves first is chlorogenic acid lactone; however, because it is not possible to 100% inhibit the production of quininic acid and caffeic acid, if the powder-to-water ratio is excessively high, a certain amount of quininic acid or caffeic acid may get dissolved. Thus, it is better to control the powder to water ratio at 1:20 to 1:33.

In addition, as far as temperature is concerned, the water temperature can be just controlled between 65° C. and 80° C. during the courses of brewing. According to research, the perception and release of coffee flavor are closely related to the drinking temperature, and the release, which includes volatiles, generally follows the Van't Hoff principle, wherein a large amount will be released when the temperature is higher than 40° C.; fatty ketones, alkyl pyrazines, certain furans and pyridines increase most significantly when the temperature is ≥50°C. Changes in volatile release curves may explain some of the sensory differences observed, flavors such as sour, tobacco, and sweet being primarily associated with coffees between 31° C.-44° C., while coffees between 50° C. and 62° C. showing stronger overall strength, roasted taste, and bitterness. It can be seen that most of the good flavor substances in coffee can be fully released when the brewing water temperature is above 65° C., and especially when the water temperature is higher than 85° C., it is easy to extract other bad substances so as to make the problem of bitter taste more obvious.

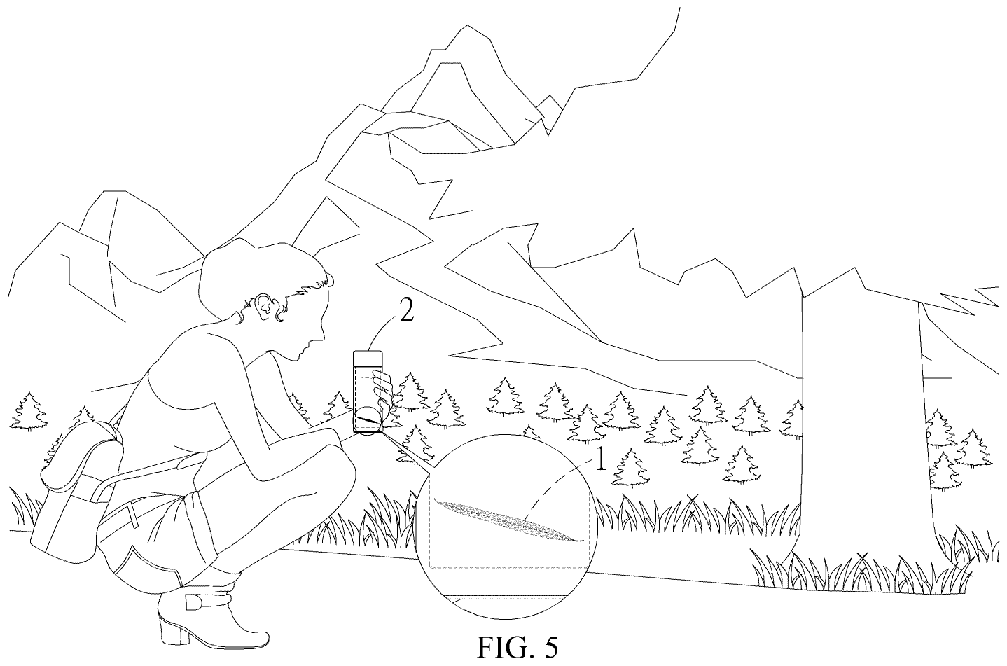

Of course, the coffee flavor being good or bad is related to personal taste, but human taste perception is on the taste buds of the tongue, and there are far more bitter taste buds than sweet taste buds, so that reducing the types of dissolved compounds can avoid a variety of bitter flavors being perceived by the taste buds and increase the sweetness ratio presented with chlorogenic acid lactone to thereby reasonably enhance the flavor of coffee. And, as the ratio of powder to water and brewing temperature are properly controlled, it is possible to effectively control the degree of extraction of coffee powder in water, so that when the solubility reaches saturation, as long as the water temperature can be maintained at 65° C.-80° C. (for example, using a covered insulated container 2), no matter how long the coffee bag 1 is soaked in the water, the drinking flavor will not be affected. In addition, as shown in FIG. 5, based on the brewing temperature of 65° C.-80° C., the present invention can also be applied to brewing at high altitudes. Since the boiling point of water will decrease by 3° C. for every rise of 1000 m, the boiling temperature of water is only 85° C. when it rises to 5000 m. Furthermore, the extraction tools on the mountain are also in a cold environment, making the actual extraction temperature even lower than 85° C. However, the present invention can use water between 65° C.-80° C. to brew rich-flavored coffee, or after simply using a thermos bottle to fill hot water, and the hot water is lowered to about 70° C., the coffee roasted with the roasting method according to the present invention can still be directly used for brewing to make rich aroma coffee.

I claim:

1. A coffee roasting method, comprising:
(A) selecting a plurality of coffee beans;
(B) preheating a bean roasting bin and adding the coffee beans and heating to a temperature recovery point;
(C) heating the coffee beans to set an internal water temperature on an edge of evaporation of 90° C.-100° C. in order to soften the coffee bean fibers for easily dispersing moisture;
(D) according to a temperature rise rate of heating the coffee beans in Step (C), continuing heating within a range of the temperature rise rate ±1.5 degrees/minute until a water content of the coffee beans is less than 5%;
(E) controlling temperature such that during first cracking, chlorogenic acid in the coffee beans undergoes a dehydration reaction in a condition of water insufficiency so as to convert into chlorogenic acid lactone; and
(F) before second cracking, stopping roasting and taking out the coffee beans before degradation of chlorogenic acid lactone.

2. The coffee roasting method according to claim 1, wherein a density of the coffee beans in Step (A) is 830 g/L to 930 g/L.

3. The coffee roasting method according claim 1, wherein in Step (D), the coffee beans are caused to reach a moisture content of less than 8% before 140° C.

4. The coffee roasting method according to claim 1, wherein in Step (D), the coffee beans are caused to reach a moisture content of less than 5% before 180° C.

5. The coffee roasting method according to claim 1, wherein in Step (E), the temperature is controlled before sucrose in the coffee beans begins to melt.

6. The coffee roasting method according to claim 1, wherein in Step (F), a roasting degree (Agtron) of the coffee beans is controlled to be greater than 52 before the second cracking for taking out the coffee beans.

7. The coffee roasting method according to claim 1, wherein after Step (F), Step (G) is carried out to grind the coffee beans into coffee powder, which is then added with water such that a power to water ratio is 1:20 to 1:33 during a course of brewing.

8. The coffee roasting method according to claim 1, wherein after Step (F), Step (G) is carried out to grind the coffee beans into coffee powder, which is then added with water such that water temperature is controlled between 65° C. and 80° C. during a course of brewing.
